(19) United States
(12) Patent Application Publication
(10) Pub. No.: US 2022/0076358 A1
(43) Pub. Date: Mar. 10, 2022

(54) Method and System to Optimize Distributed Charging Station Efficiency and User Experience

(71) Applicant: Bayerische Motoren Werke Aktiengesellschaft, Muenchen (DE)

(72) Inventors: Yang CAO, Chicago, IL (US); Jilei TIAN, Chicago, IL (US)

(21) Appl. No.: 17/418,466

(22) PCT Filed: Oct. 21, 2019
(86) PCT No.: PCT/EP2019/078609

§ 371 Date: Jun. 25, 2021

(30) Foreign Application Priority Data
Feb. 28, 2019 (EP) 19159973.7

(51) Int. Cl. G06Q 50/06; G06Q 10/06; G06F 17/12; G01C 21/34; B60L 58/13; B60L 53/67; B60L 53/64

(52) U.S. Cl. CPC G06Q 50/06; G06Q 10/06315; G06F 17/12; G01C 21/3415; G01C 21/3407; B60L 2240/70; B60L 53/67; B60L 53/64; B60L 2260/54; B60L 2260/52; B60L 2240/68; B60L 58/13

(57) ABSTRACT

A computer-implemented method for allocating charging stations including a) receiving charging station data, the charging station data identifying one or more charging stations and charging station locations; b) receiving one or more requests to charge one or more requesting vehicles, each request including data identifying a departure location and an arrival location of the respective requesting vehicle; c) receiving and/or determining detours data, the detours data indicating at least one charging station detour distance for a plurality of vehicles, the plurality of vehicles including the requesting vehicles; d) identifying charging station candidates for the requesting vehicles by optimizing an objective function with linear constraints; and e) allocating at least some of the charging station candidates to the requesting vehicles; wherein optimizing the objective function with linear constraints includes reducing a waiting time in the queue, price, a total detour distance for the requesting vehicles.

### BACKGROUND AND SUMMARY OF THE INVENTION

The invention relates to a method for optimized allocation of highly distributed charging stations to electrical vehicles to improve charging stations efficiency and to improve user experience, and to a computer-readable medium and a system for the same.

With more regulatory pressures on combustion engines and rapid technological improvements in electric powertrains and batteries, there is a rapid growth of demand for electric vehicles (EVs). For EVs, one of key challenges affecting user experience is the battery charging, since an EV tends to have shorter range and longer charging time, compared to combustion engine propelled vehicles.

There are several approaches to improve the experience of charging electrical vehicles. One approach includes exchangeable batteries, i.e. drive the vehicle to the charging station, and replace low power batteries with fully charged batteries. This solution needs substantial investment in technology and service facilities, and systems to automate the battery exchange. Manufacturers also need to invest to make the exchangeable batteries reliable. Consumers with new vehicles need to accept and support that their new batteries may be exchanged for older ones. Insurance companies will also have to adapt their policies according to this change. Further, it is difficult to distribute this service widely.

Another approach is aiming to improve the user experience by positioning charging station locations on an interactive map and allowing users to navigate to the charging stations based on the locations of the map.

This invention suggests a new approach to improve the user experience. In an embodiment, the invention allows optimization of a total detour distance for charging a plurality of vehicles, in contrast to optimizing the charging detour distance for each vehicle separately. The optimization on detour distance is an example and the invention may be optimizing any target, such as prices for charging or waiting time in queues, such as for vehicles queueing for charging. The optimization may be on one of the targets. The optimization may also be on more than one target simultaneously, such as by weighting targets. The objective may also include several optimization targets, that preferably are weighted with respect to each other. The optimization may also include one or more constraints as described herein.

Gasoline refueling services generally is dependent on investment in infrastructure in rather complex and dangerous equipment due to the gasoline supply management, such a pipelines and/or fuel delivery etc. This has resulted into branded services, e.g. Shell, BP, etc.

In contrast to gasoline refueling, due to the rather low cost of infrastructure investment and safe and ease of use, individuals can own charging facilities for their EV. The invention includes realizing that individuals may in theory offer their charging station as a service. The invention further includes realizing that this may lead to a trend shift in the distribution of charging stations services, in terms of geographical locations, and in terms of ownership. Charging station services can be highly distributed. The invention includes realizing the possibilities, and also the technical challenges this potential trend shift may lead to. The invention also includes addressing the technical challenges with a technical solution for optimizing charging station allocation in such a highly distributed environment of charging services.

For highly distributed service supply and demand, it is critical to have the platform to optimally manage the supply and demand in a distributed system due to increased complexity of search and selection, with user experience as the constraint, e.g. to reduce the customer's cost of driving, waiting and money, and optimize the business value for the service supplier.

This invention proposes an approach to charging service as the whole system to optimize the performance and value between supplier and demand. In such a system, it is an object of the present invention, to optimally allocate charging stations to electrical vehicles.

The allocation of charging stations is solved by the claimed invention.

In particular, the object of the present invention is solved by a computer-implemented method for allocating charging stations, the method comprising:

a) receiving charging station data, the charging station data identifying one or more charging stations and charging station locations;

b) receiving one or more requests to charge one or more requesting vehicles, each request comprising data identifying a departure location and an arrival location of the respective requesting vehicle;

c) receiving and/or determining detours data, the detours data indicating at least one charging station detour distance for a plurality of vehicles, the plurality of vehicles including the requesting vehicles;

d) identifying charging station candidates for the requesting vehicles by optimizing an objective function with linear constraints; and

e) allocating at least some of the charging station candidates to the requesting vehicles;

wherein optimizing the objective function with linear constraints includes reducing a total detour distance, waiting times in a queues, and/or prices for charging for the requesting vehicles.

The requesting vehicle may be able to know feasible routes between departure location and arrival location. Determining detours data may be done based on feasible routes between these locations and charging station locations.

The advantages include, in particular for highly distributed charging stations, optimizing charging stations efficiency and user experience.

The advantages of the holistic approach and the allocation of charging stations include an improved utility of charging stations. The objective may be to optimize across vehicles/users (demand) and service providers (supply). This may in turn lead to improved value for suppliers and consumers. For suppliers, the invention may enable and motivate more charging facilities for public use, as well as allow service providers to maximize their profit with the system being easy to manage, as well as meeting personal service availability. For consumers, the system allows reduced charging costs, and reduced waiting and detour distance over time. The method may be used to recommend, and remind users of the best time and location for charging their vehicle, e.g. short detour, low price, no waiting time, optimal charging efficiency. The invention has further advantages for transportation based on autonomous vehicles, where vehicles may be adapted drive and charge themselves without passengers. Total detour distance, and so cost of transportation, may be reduced by optimizing on a fleet of vehicles, rather than optimizing for each vehicle individually. The advantages also include values for the community and the ecosystem such as environment, traffic, utility and energy efficiency.

The request for charging may be done manually by a user of an EV, or may be done automatically by the EV itself when it, based on sensor inputs, considers that it needs charging.

Alternatively, the request may triggered centrally, such as in a central charging station allocation unit, the charging station allocation unit being updated (such as by pull or push messages) from an EV with EV data needed for the charging station allocation unit to make a decision that an EV needs charging. Such data may include current battery levels and/or distance to charging stations. The charging station allocation unit may administer a charging station allocation schedule for one or more vehicles that may be updated as described herein based on data from vehicles.

Charging station candidates may be presented to users of vehicles and in response to the presentation, the user may acknowledge the candidate and reserve the charging station so that the charging station is allocated to the vehicle. The allocation may also be automatic, for some or all vehicles, in response to identifying charging station candidates.

The optimizing of the objective function, and the allocation of charging stations, may be performed each time a new vehicle requests charging. It is then possible for a user experience that an initial short detour for charging is progressively increased the closer in time the charging is scheduled to be, as more vehicles are added to the optimization. This may be perceived by consumers as unjust. Alternatively, the optimization may be done at certain intervals, where already allocated charging stations are not updated as more vehicles are requesting charging. “Early birds” will then have more charging stations included in the optimization and a higher likelihood of short detour distances. This might lead to a delay for users to be suggested charging station candidates and may therefore be better suited for automatic allocation of charging stations. For autonomous vehicles, and in particular when driving for charging without a passenger, the re-allocation will be less problematic.

In one embodiment, the charging station detour distance is a difference in distance between a first distance of a path going from the departure location to the arrival location via the charging station locations, and a second distance of a path going from the departure location directly to the arrival location.

The advantages include an accurate and fast method for deriving the detour distance that the allocation of charging stations may be optimized on.

In one embodiment, the method further comprises the step of

determining if a respective vehicle needs charging and issuing the request to charge based on the result of the determining step;

wherein the vehicles is determined to need charging if an expected battery level is below a threshold battery level; and

wherein the plurality of vehicles includes the requesting vehicle if the requesting vehicle needs charging.

A challenge with a system approach is the complexity of the optimization problem and the increased computational demands with an increased number of requesting vehicles and charging stations. The advantages include a reduced number of vehicles by only including vehicles that are in need of charging at any moment in time. The determining if the vehicle needs charging may be automatic, and a charging station proposed to the driver, reducing the attention needed by the driver on the battery level of the vehicle, further increasing the focus on driving and increasing safety.

For autonomous vehicles, the vehicle may schedule a charging after the current driving route is completed, when the battery level is below a threshold level. The departure location for calculating the detour may then be the destination of the current route, and the arrival location for calculating the detour may be the start (pick-up) location of the next route.

In one embodiment, identifying charging station candidates includes determined if a charging station is a valid candidate for a vehicle, in particular one of the requesting vehicles, where the charging station is a valid candidate for the vehicle if:

i) the charging station detour distance for the vehicle going via the charging station is below a detour distance threshold; and/or
ii) the charging station is reachable by the vehicle, where the charging station may be considered to be reachable if an expected battery consumption between the departure location and the charging station location is below a current battery level; and/or
iii) the charging station is reachable by the vehicle within opening hours of the charging station.

The advantages include reducing the complexity of computations by reducing the number of vehicle candidates for each charging station. By pre-filtering vehicles based on their location and battery level, the optimization problem may be substantially reduced in complexity. Further, by including a detour distance threshold the method prevents outliers, i.e. vehicles travelling far for the sake of reducing the overall detour distance. The method may be adapted so that autonomous empty vehicles have a higher detour distance threshold than vehicles with passengers. The detour distance may be in absolute terms of detour distance, or in relative terms (such as a percentage) of the tour distance without charging.

In one embodiment, at least one request identifies an earliest departure time, and the linear constraints include the earliest departure time whereas a charging station candidate is identified and allocated for the vehicle of the request so that the vehicle of the request is scheduled to depart for charging after the earliest departure time; and/or wherein at least one request identifies an latest departure time, and the linear constraints include the latest departure time whereas a charging station candidate is identified and allocated for the vehicle of the request so that the vehicle of the request is scheduled to depart for charging before the latest departure time.

The advantages include a further constraint to allow charging station detours to be better planned in advance for charging during a planned future route. For autonomous vehicles, the earliest departure time may be the estimated arrival time of the present tour, so that the autonomous vehicle may drop off traveling passengers, before initiating driving to an allocated charging station for charging.

In one embodiment, the charging station data further identifies opening hours of at least one of the charging stations and the objective function and/or the linear constraints include the opening hours so that the objective function is optimized, and the vehicles are scheduled for charging during the opening hours.

The advantages include further constraints to allow for charging station to be out of service during a certain time period. The constraints allow optimization of routes to take into consideration that charging stations may be needed by the owner, be pre-booked, need maintenance, or need to be closed for service or for other reasons.

In one embodiment, identifying charging station candidates includes determining a time window for the requesting vehicles, and the linear constraints are adapted so that the requesting vehicles are exclusively allocated to a charging station during the time window; and wherein the method further may comprise:

f) determine a departure time for each of the requesting vehicles so that the vehicles is estimated to arrive to the charging station before the start of the time window.

The advantages include that a vehicle is signaled a departure time, so that the vehicle is estimated to arrive at the charging station in time for the allocated time window for charging. It prevents vehicles from departing too early, which may lead to waiting time at the charging station, and clogging of the charging station approach way. If the vehicle departs after the determined departure time, the system may be notified, and the vehicle may be re-allocated a new time window at the same chagrining station, or re-allocated another charging station that is available according to the method described herein.

In one embodiment, the linear constraints include the constraint:

s_{i,j}≥q_{k,j} or s_{k,j}≥q_{i,j}∀j∈C∀i,k∈U(j)i≠k

where

$$variable {s}_{i , j} = \{ \begin{matrix}charging start time at j , & if {e}_{i , j} = 1 \\ 0 , & otherwise\end{matrix}$$

for every user i∈U and charging station j∈C(i), i.e the start of the time window;

variable q_{i,j} denotes the time that vehicle i is finished charging at charging station j, i.e. the end of the time window;

e_{i,j} is a binary variable that is 1 if vehicle i will visit charging station j, 0 otherwise.

The advantages of including the above linear constraints include that the allocation of charging stations ensures that every charging station is only allocated to one vehicle at any one point in time. If a location contains several charging stations, each charging station is optimized as a separate charging station.

In one embodiment, the objective function and/or the linear constraints include a cost of charging each of the vehicles.

The cost of charging may be a constraint, such as a maximum cost set by a user, or included as a minimization target, to reduce the total cost of charging. The optimization may be balanced with the total detour so that vehicles allocated a charging station with short detour (such as popular charging stations) are charged a higher price than vehicles allocated a charging station with longer detour (such as less popular charging stations). This may lead to an cost effective allocation of vehicles, while supplier increases the value of service, and the cost of charging and detour decreases, and may be used to provide suggestions for installation of further charging stations at locations which would have a high value of service, that in turn would lead to a decrease in total charging detour distance.

In one embodiment, the request further identifies current battery level and an energy consumption per distance unit for a requesting vehicle and at least one of the charging station data identifies a price per hour and/or price per energy unit; and

wherein the cost of charging is derived from the current battery level, the energy consumption per distance unit, a distance to each of the charging stations, and the price per hour and/or price per energy unit identified by the charging station data.

The advantages include a service that allows the total cost of charging the vehicle to full at each charging station, taking into consideration the current battery level and energy consumption to drive to the charging station. By including the charging price, such as per hour usage, or per energy unit charged, the supplier can adjust the price so that total return on investment is optimized. The system may suggest a suitable charging price as a service, or set the price directly, taking into consideration the demand to charge at the charging station.

In one embodiment, identifying charging station candidates includes applying a branch and bound method to optimize the objective function with the linear constraints.

The advantages include an algorithm that finds an optimal solution with reasonable computational resources and leads to a reduction in computational usage. Branch and bound is only an example of a technique to solve the mixed-integer programming problem. Any other suitable method may be used, needed, or developed.

In one embodiment, optimizing the objective function includes maximizing the function

$${\sum }_{i ∈ U} {\sum }_{j ∈ C ( i )} {e}_{i , j} - {σ}_{1} {\sum }_{i ∈ U} {\sum }_{j ∈ C ( i )} {e}_{i , j} * d e t o u {r}_{i , j} - {σ}_{2} {\sum }_{i ∈ U} {\sum }_{j ∈ C ( i )} {e}_{i , j} * p {c}_{i , j}$$

where i∈U denotes a set of vehicle identifiers;

j∈C(i) denotes a set of charging station identifiers;

e_{i,j} is a binary variable that is 1 if vehicle i will visit charging station j, 0 otherwise;

detour_{i,j} denotes the charging station detour distance for vehicle i if driving via charging station locations j on its way from the departure location to the arrival location of the vehicle;

pc_{i,j} denotes the cost of charging vehicle i at charging station j;

σ₁ and σ₂ are predefined hyperparameters in the range of:

$$0 < {σ}_{1} \leq \frac{1}{{max}_{i , j} {detour}_{i , j}} \\ 0 < {σ}_{2} \leq \frac{1}{{max}_{i , j} ( p {c}_{i , j} )}$$

The advantages include a method that provides a solution that is optimal considering a trade-off between minimizing detour distance and minimizing charging costs. The trade-off may be adjusted by the parameters σ₁ and σ₂ and may be predetermined or adjusted dynamically depending on conditions.

In one embodiment, the linear constraints include:

$$\{ \begin{matrix}{s}_{i , j} \geq ( t {s}_{i} + t s {c}_{i , j} ) * {e}_{i , j} & ∀ i ∈ U , ∀ j ∈ C ( i ) \\ {s}_{i , j} \leq ( t {e}_{i} + t s {c}_{i , j} ) * {e}_{i , j} . & ∀ i ∈ U , ∀ j ∈ C ( i )\end{matrix} \\ an \text{d/o} r \\ \{ \begin{matrix}{s}_{i , j} \geq o {s}_{j} * {e}_{i , j} & ∀ i ∈ U , ∀ j ∈ C ( i ) \\ {s}_{i , j} + d {u}_{i , j} * {e}_{i , j} \leq o {e}_{j} * {e}_{i , j} & ∀ i ∈ U , ∀ j ∈ C ( i )\end{matrix} \qquad$$

where

e_{i,j} is a binary variable that is 1 if vehicle i will visit charging station j, 0 otherwise;

tsc_{i,j} denotes the travel time between the departure location of vehicle i and the charging station location of charging station j;

tsᵢ and teᵢ are the earliest departure time and latest departure time respectively for vehicle i;

$$variable {s}_{i , j} = \{ \begin{matrix}charging start time at j , & if {e}_{i , j} = 1 \\ 0 , & otherwise\end{matrix}$$

for every user i∈U and charging station j∈C(i);

osⱼ and oeⱼ are the opening time and closing time respectively for charging station j;

du_{i,j} denotes the charging time for vehicle i at charging station j.

The advantages include an allocation of charging stations that ensures that vehicles are able to reach and complete charging within the operation hours of the respective allocated charging station.

In particular, the object of the present invention is solved by a computer readable medium comprising instructions, when executed by a processor, that cause the processor to carry out the method as described herein.

The benefits and advantages of the aforementioned computer readable medium are equal or similar to the advantages of the above-mentioned method.

In particular, the object of the present invention is solved by charging station allocation system comprising:

a charging station allocation unit;

a charging station;

wherein the charging station allocation unit is adapted to carry out the method as described herein; and

wherein the charging station allocation unit is further adapted to, based on the result of the step to allocate, send a signal to the charging station, the signal including an allocation message relating to a particular requesting vehicle and a corresponding time window.

The advantages include that distributed charging stations are informed of their allocation to vehicles which, for instance, may allow the charging station to prepare for charging such as indicating that the charging station is allocated to a vehicle. These preparations may include filling short term energy buffers, and/or adjusting voltage/ampere and/or connectors to the vehicle to which it is allocated. The benefits and advantages of the system are further equal or similar to the advantages of the method described herein.

In one embodiment, the charging station is able to identified the particular requesting vehicle; and

wherein the charging station allocation system prevents vehicles other than the particular requesting vehicle from using the charging station during the corresponding time windows.

The advantages include that the charging station is available, i.e. not occupied, when the vehicle to which it is allocated is arriving for charging. This prevents re-allocating the allocated vehicle and a suboptimal re-routing and/or waiting of vehicles to be charged.

In the following, embodiments of the invention are described with respect to the figures.

### BRIEF DESCRIPTION OF THE DRAWINGS

FIG. 1 illustrates a vehicle departure and arrival locations, and detours for charging at alternative charging stations.

FIG. 2 illustrates steps of a method according to one embodiment of the invention.

FIG. 3 illustrates vehicle and charging station data processing and charging station allocation according to one embodiment of the invention.

FIG. 4 schematically illustrates a charging station allocation system according to one embodiment of the invention.

### DETAILED DESCRIPTION OF THE DRAWINGS

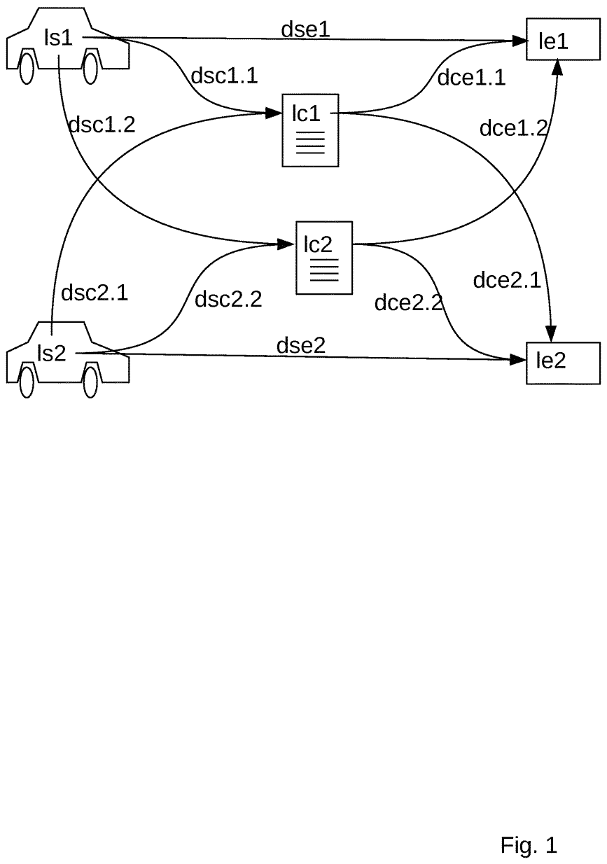

FIG. 1 shows a first charging station location lc1, a second charging station location lc2, a departure location for a first vehicle ls1, a departure location for a second vehicle ls2, an arrival location for the first vehicle le1, an arrival location for the second vehicle le2, a distance from the departure location to the arrival location for the first vehicle dse1, a distance from the departure location to the arrival location for the second vehicle dse2, a distance from ls1 to lc1 (dsc1.1), a distance from ls1 to lc2 (dsc1.2), a distance from ls2 to lc1 (dsc2.1), a distance from ls2 to lc2 (dsc2.2), a distance from lc1 to le1 (dse1.1), a distance from lc2 to le1 (dse1.2), a distance from lc1 to le2 (dse2.1), and a distance from lc2 to le2 (dse2.2). the same naming convention applies to other parameters, e.g. travel duration, time instance, departure and destination locations, etc.

The invention involves allocating charging stations (at location lc1 and lc2) to vehicles (with departure locations ls1 and ls2) by optimizing an objective function, so that the total detour distance is minimized. In the example of FIG. 1, involving two vehicles and two charging stations, there are two possible solutions. The number of vehicles and charging stations in FIG. 1 is an example, and the invention may process any number of vehicles and charging stations for allocation. The number of possible solutions, and so the complexity of the computations, increases with the number of vehicles and charging stations processed.

The following notation is used for the ith user or vehicle, and jth charging station:
lsᵢ, leᵢ and lcⱼ denote the vehicle departure and arrival locations for the ith user, and the jth charging location, respectively.
dseᵢ and tseᵢ denote the driving distance and trip duration from the departure and arrival destinations for the ith user.
For the ith user, the earliest departure time is tsᵢ, the last departure time is teᵢ, the current battery level is Bᵢ; for the jth charging station, the price per hour is pⱼ, the opening time is from osⱼ to oeⱼ; if one charging station has multiple charging devices, split it into multiple virtual charging stations with each having 1 charge device.
Users who need charge service are denoted as U, Charging station list is denoted as C, for user i∈U, the valid charging station candidates for i is denoted as C(i), similarly, U(j) means all users who have j as their charging station candidate.

Generally the first letter of a notation means Location (l), Distance (d), Duration or time (t), Price (p), Battery level (B), Opening (o).

The notations for distance (d) and time (t) have generally three letters where the second denotes the starting point: starting location (s) or charging location (c), and the third denotes the end point: charging location (c) or end location (e).

The notations for location (l) generally have two letters, where the second denotes location, such as start location (s), charging location (c), and end location (e).

Where the notations have a subscript, the first one (i) generally refers to the vehicle/user ID, and the second one (j) generally refers to the charging station ID.

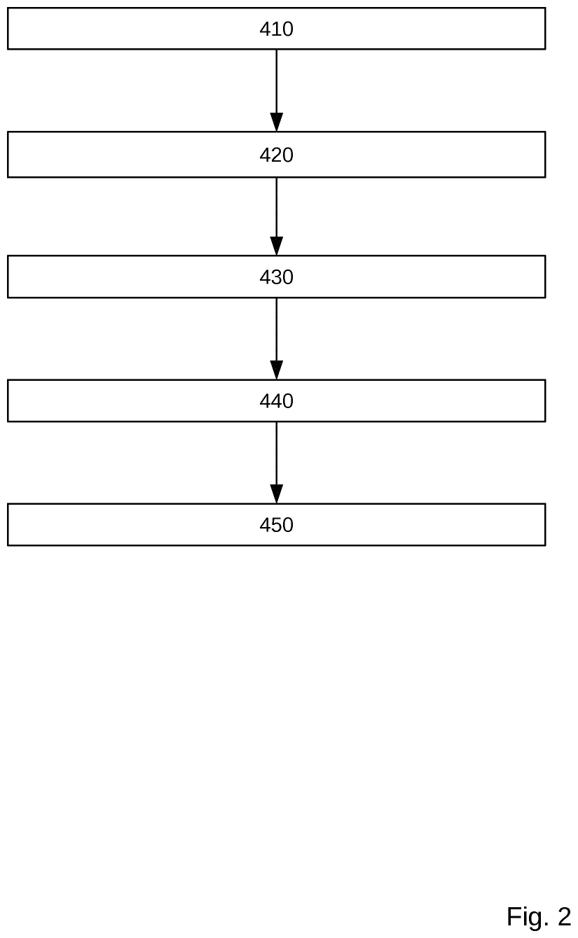

FIG. 2 shows steps of a method according to one embodiment of the invention. The method includes a step of receiving charging station data 410, a step of receiving and/or determining one or more requests to charge a requesting vehicle 420, a step of receiving and/or determining detours data 430, a step of identifying charging station candidates 440, and a step of allocating charging stations to vehicles 450. The method may also include a step of determining departure time for the vehicles (not shown).

The step of identifying charging station candidates may include finding potential charging station candidates for the users who demand charging service and recommending users charging stations, including the optimized charging time, and that meet user's charging requests, while keeping the overall price and detour distance optimized using mixed integer programming.

Finding potential charging station candidates for the users who demand charging service may include (example):
Initial: U={ }
For the user i, calculate dseᵢ=dist(lsᵢ,leᵢ), get the battery consumption bseᵢ based on dseᵢ. If Bᵢ−bseᵢ>Thrdᵢ, it means the user doesn't need charging service, or a different user may have a different threshold, (for example, if user has charge device at home, the threshold can be low). If user i needs charging service, U=U∪{i}, C(i)={ }

For each charging station j, check if j is a valid candidate for user i by calculating the following:
dsc_{i,j}=dist(lsᵢ,lcⱼ), dce_{i,j}=dist(lcⱼ,leᵢ), detour_{i,j}=dsc_{i,j}+dce_{i,j}−dseᵢ. If detour_{i,j}>dseᵢ*Threᵢ, it means that charging station j is not suitable for the user since the detour distance is bigger than the user preference, skipping the following step; here Threᵢ means the detour threshold that user i can accept.
Get the travel time between lsᵢ and lcⱼ as tsc_{i,j}, calculating the battery consumption between lsᵢ and lcⱼ as bsc_{i,j}, if bsc_{i,j}≥Bᵢ+τ, it means that j is not reachable with user's current battery level (here τ is a small safeguard value to ensure j is reachable), skipping the following step; otherwise calculate the charging time tc_{i,j} and price pc_{i,j} based on the battery level (Bᵢ−bsc_{i,j}).
Check time windows compatibility:
   If teᵢ+tsc_{i,j}<osⱼ, it means that the opening time of j is too late for the user, skip j
   If tsᵢ+tsc_{i,j}+ct_{i,j}≥oeⱼ, it means that the opening time of j is too early for the user, skip j
Check another user request, for example, some users may specify the charging price should be lower than a certain value, if j meets all requirements, append the charging candidate list as C(i)=C(i)∪{j}

Global optimization may include an objective of optimization to recommend each user to the best charging station and the best time user starts the charging. The following variables are introduced:
Binary variable e_{i,j} for every user i∈U and charging station j∈C(i); e_{i,j}=1 means user i will visit and charge at station j. The variable represents the recommendation of a user to the best charging station.

$$Floa \text{t-p} oint variable {s}_{i , j} = \{ \begin{matrix}charging start time at j , & if {e}_{i , j} = 1 \\ 0 , & otherwise\end{matrix}$$

for every user i∈U and charging station j∈C(i). The variable represents the charging start time for the user. Define q_{i,j}=s_{i,j}+du_{i,j}*e_{i,j}, it is obvious that q_{i,j} means the time that the user finished charging at j if e_{i,j}=1; otherwise q_{i,j}=0. Here the time unit is minutes to 0 am, for example, 541 means 9:01 am.

The objective may be to meet the most charging requests while keeping the entire price and detour smallest. The objective function is expressed as maximizing (example):

$${\sum }_{i ∈ U} {\sum }_{j ∈ C ( i )} {e}_{i , j} - {σ}_{1} {\sum }_{i ∈ U} {\sum }_{j ∈ C ( i )} {e}_{i , j} * d e t o u {r}_{i , j} - {σ}_{2} {\sum }_{i ∈ U} {\sum }_{j ∈ C ( i )} {e}_{i , j} * p {c}_{i , j} \qquad$$

Where σ₁ and σ₂ are predefined hyperparameters, that may be in the range of:

$$0 < {σ}_{1} \leq \frac{1}{{max}_{i , j} {detour}_{i , j}} \\ 0 < {σ}_{2} \leq \frac{1}{{max}_{i , j} ( p {c}_{i , j} )}$$

Linear constrains for optimization may include
Every user can visit no more than 1 charging station.

Σ_{j∈C(i)}e_{i,j}≤1∀i∈U (1)
Ensure that the charging start time is consistent with the user's departure time window.

$$\{ \begin{matrix}{s}_{i , j} \geq ( t {s}_{i} + t s {c}_{i , j} ) * {e}_{i , j} & ∀ i ∈ U , ∀ j ∈ C ( i ) \\ {s}_{i , j} \leq ( t {e}_{i} + t s {c}_{i , j} ) * {e}_{i , j} . & ∀ i ∈ U , ∀ j ∈ C ( i )\end{matrix} \qquad ( 2 )$$

Ensure that the charging time is consistent with the charging station's opening time.

$$\{ \begin{matrix}{s}_{i , j} \geq o {s}_{j} * {e}_{i , j} & ∀ i ∈ U , ∀ j ∈ C ( i ) \\ {s}_{i , j} + d {u}_{i , j} * {e}_{i , j} \leq o {e}_{j} * {e}_{i , j} & ∀ i ∈ U , ∀ j ∈ C ( i )\end{matrix} \qquad ( 3 )$$

At any time, ensure that at the most only one car can use the charging service at one charging station. [s_{i,j},q_{i,j}] is the time that window user i charges at j, (If user didn't visit j, [s_{i,j},q_{i,j}]=[0,0]), it is easy to verify that if j is not visited by both i and k, (4) is always true; if both i and k visited j, (4) ensures the charging time windows of i, k have no overlap.

s_{i,j}≥q_{k,j} or s_{k,j}≥q_{i,j}∀j∈C∀i,k∈U(j)i≠k (4)
In MIP, it is not able to process the “or” operator defined in (4), Instead we transformed it into linear constraint by introducing a new binary variable y_{i,k,j}, replacing q_{i,j}=s_{i,j}+du_{i,j}*e_{i,j}, (4) could be rewritten as:

$$\{ \begin{matrix}{s}_{i , j} - {s}_{k , j} - {du}_{k , j} * {e}_{k , j} \geq - M * {y}_{i , k , j} \\ {s}_{k , j} - {s}_{i , j} - {du}_{i , j} * {e}_{i , j} \geq M * ( 1 - {y}_{i , k , j} )\end{matrix} \qquad ( 5 )$$

Where M is a big constant, for example taking a maximum opening duration of the charging station.

Using a method for solving mixed integer programming (MIP) problems, such as branch and bound, optimized values of e_{i,j},s_{i,j} for every (i,j)i∈U,j∈C(i) according to the constraints defined in (1)-(3), (5) with the objective function to be optimized. For a user i, the start time for the charging time is given below:

$${\dot{s}}_{ι} = {s}_{i , {j}^{*}} = {max}_{j ∈ U ( i )} {s}_{i , j} ; \qquad$$

Among all charging stations, only one station is visited per user, so only one of s_{i,j} is bigger than 0.

If \dot{s}ₜ>0, user i is recommended to charge at station j* at time \dot{s}_{ι}. Thus the departure time should be \dot{s}t_{ι}=\dot{s}ₜ−tsc_{i,j*}. A push notification should be sent to the user i perhaps 15 minutes before \dot{s}t_{ι}, the notification will contain information such as time-to-leave, navigation info about the charging station to go to (j*).

From the objective function, the system recommends to the user the charging station that intends to be optimal for price and detour while meeting all conditions in the personal request.

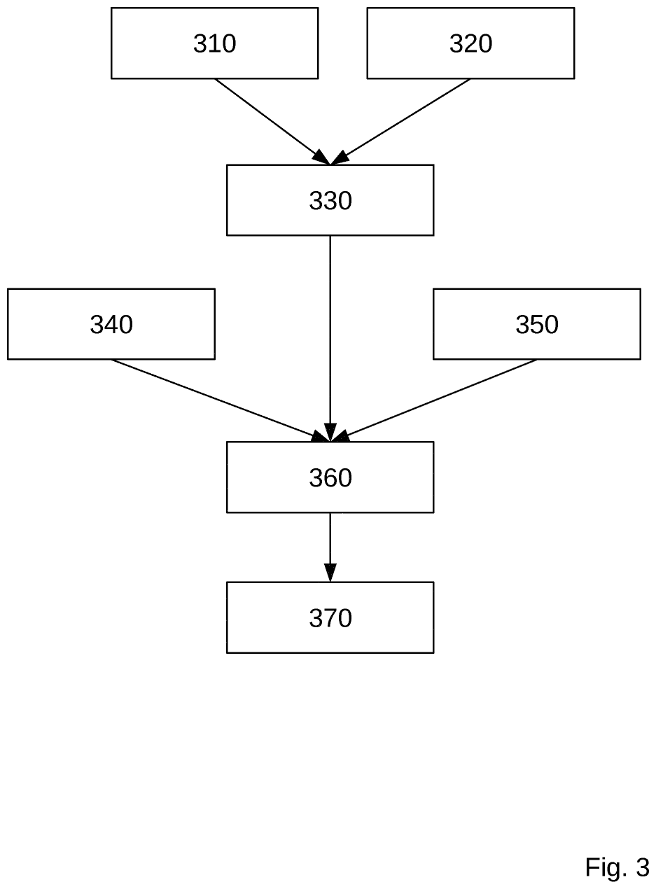

FIG. 3 shows an embodiment comprising vehicle data 310, charging station data 320, pre-filtering module 330, objective function 340, constraints 350, optimization module 360, and allocation module 370. Vehicle data 310 contains information regarding an electrical vehicle, such as locations, battery levels, current and planned trip information, etc. Charging station data 320 contains information regarding charging stations, such as locations, price schemes and prices, availability, opening hours, etc. Optional pre-filter module 330 filters vehicles and/or charging stations. The pre-filter module 330 may filter vehicles that are in need of charging as described herein. Pre-filter module 330 may also reduce the number of potential charging stations for each vehicle by filtering charging stations that clearly are beyond reach for each vehicle as described herein. Optimization module 360 finds optimal charging stations for vehicles by optimizing the objective function 340 on the vehicle data 310 and charging station data 320 (that may have been pre-filtered). Optionally, the optimization module 360 may apply constraints 350 (such as linear constraints) as described herein when finding optimal charging stations for vehicles. The optimal charging stations may optionally be proposed to the users/vehicles as candidates. Allocated module 370 allocated the charging stations to the vehicles.

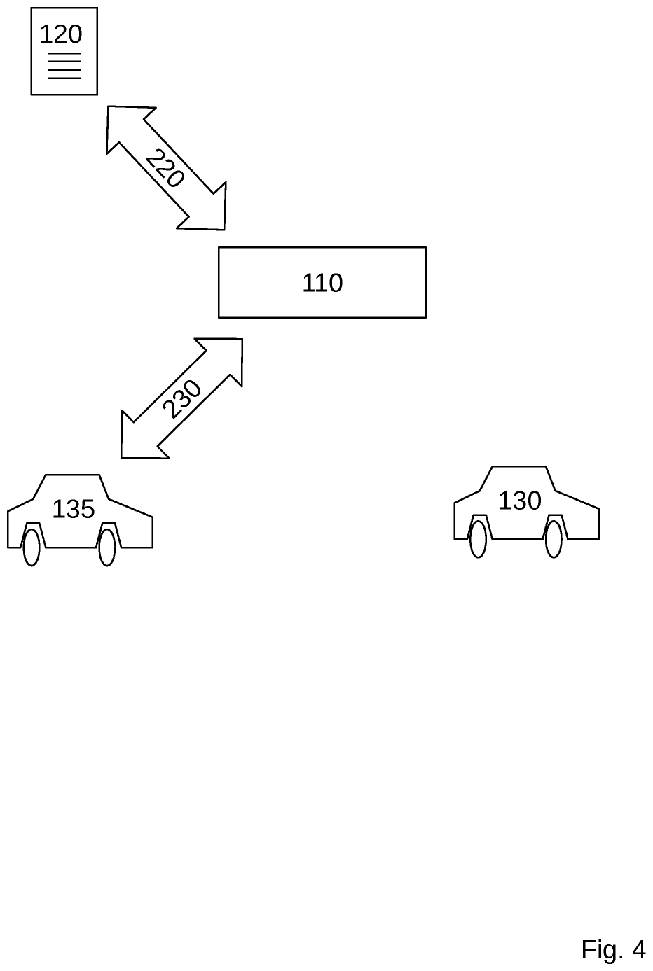

FIG. 4 shows charging station allocation unit 110, charging station 120, vehicle 135, charging station communication channel 220, and vehicle communication channel 230.

Charging station allocation unit 110 may receive a request from vehicle 135 (such as via vehicle communication channel 230), to charge a vehicle. The charging station allocation unit 110 may, using the data provided in the request, allocate charging station 120 to vehicle 135 using a method as described herein. The charging station allocation unit 110 may also propose charging station 120 to vehicle 135 (and temporary book charging station 120), based on data provided in the request, and the vehicle may, in response, confirm the proposal. The charging station 120 may be allocated to vehicle 135 on receipt of the confirmation.

The charging station allocation unit 110 may further, such as via charging station communication channel 220, signal the allocation of charging station 120 to charging station 120. The charging station 120 may prevent other vehicles, such as vehicle 130, from using the charging station during the allocation to vehicle 135.

The method and/or the charging station allocation unit 110 may be implemented in a platform for allocating charging stations to vehicles. The platform may allow suppliers and consumers to interact with the platform. Charging station suppliers may, as examples, provide the following information to the platform: operation business hours, pricing policy such as charging flat fee or price per hour or price per energy unit, or earning target, etc. The platform may offer the following information to the suppliers: allocation of charging station to vehicle, suggestion for optimizing the business value.

Consumers may provide the following information to the platform: information about the current location and battery level, information about the next trip, selection and confirmation for the recommended charging service. The platform may further offer the following information to consumers: recommend the charging service, optimize the consumer experience to minimize the charging cost, information for navigation to the charging station from the departure or current location.

The platform is provided with valuable data on charging stations and vehicles. It may optimize the global system performance as a whole, as well as bring the personal intelligence and relevant service for consumers. The platform enables highly distributed charging services to work efficiently, including large amount of small service providers through the recommendation and price policy.

### REFERENCE NUMERALS

lc1 first charging station location
lc2 second charging station location
ls1 departure location for first vehicle
ls2 departure location for second vehicle
le1 arrival location for first vehicle
le2 arrival location for second vehicle
dse1 distance from departure location to arrival location for first vehicle
dse2 distance from departure location to arrival location for second vehicle
dsc1.1 distance from ls1 to lc1
dsc1.2 distance from ls1 to lc2
dsc2.1 distance from ls2 to lc1
dsc2.2 distance from ls2 to lc2
dce1.1 distance from lc1 to le1
dce1.2 distance from lc2 to le1
dce2.1 distance from lc1 to le2
dce2.2 distance from lc2 to le2
110 charging station allocation unit
120 charging station
135 vehicle
220 charging station communication channel
230 vehicle communication channel
310 vehicle data
320 charging station data
330 pre-filtering
340 objective function
350 constraints
360 optimization
370 allocation
410 receiving charging station data
420 receiving and/or determining one or more requests to charge a requesting vehicle
430 receiving and/or determining detours data
440 identifying charging station candidates
450 allocating charging stations to vehicles

1.-16. (canceled)

17. A computer-implemented method for allocating charging stations, the method comprising:
receiving charging station data, the charging station data identifying one or more charging stations and charging station locations;
receiving one or more requests to charge one or more requesting vehicles, each request comprising data identifying a departure location and an arrival location of the respective requesting vehicle;
at least one of receiving or determining detours data, the detours data indicating at least one charging station detour distance for a plurality of vehicles, the plurality of vehicles including the requesting vehicles;
identifying charging station candidates for the requesting vehicles by optimizing an objective function with linear constraints; and
allocating at least some of the charging station candidates to the requesting vehicles;
wherein optimizing the objective function with linear constraints includes reducing at least one of a total detour distance, waiting times in queues, or prices for charging for the requesting vehicles.

18. The method of claim 17,
wherein the charging station detour distance is a difference in distance between a first distance of a path going from the departure location to the arrival location via the charging station locations, and a second distance of a path going from the departure location directly to the arrival location.

19. The method of claim 17, further comprising:
determining if a requesting vehicle needs charging and issuing a request to charge based on a result of the determining step;
wherein the vehicle is determined to need charging if an expected battery level is below a threshold battery level; and
wherein the plurality of vehicles includes the requesting vehicle if the requesting vehicle needs charging.

20. The method of claim 17, wherein:
identifying charging station candidates includes determined if a charging station is a valid candidate for a vehicle, wherein the vehicle is one of the requesting vehicles, wherein the charging station is a valid candidate for the vehicle if at least one of:
i) the charging station detour distance for the vehicle going via the charging station is below a detour distance threshold;
ii) the charging station is reachable by the vehicle, where the charging station is reachable by the vehicle if an expected battery consumption between the departure location and the charging station location is below a current battery level; or
iii) the charging station is reachable by the vehicle within opening hours of the charging station.

21. The method of claim 17, wherein at least one of:
at least one request identifies an earliest departure time, and the linear constraints include the earliest departure time whereas a charging station candidate is identified and allocated for the vehicle of the request so that the vehicle of the request is scheduled to depart for charging after the earliest departure time; or
wherein at least one request identifies a latest departure time, and the linear constraints include the latest departure time whereas a charging station candidate is identified and allocated for the vehicle of the request so that the vehicle of the request is scheduled to depart for charging before the latest departure time.

22. The method of claim 17, wherein:
the charging station data further identifies opening hours of at least one of the charging stations,
at least one of the objective function or the linear constraints include the opening hours so that the objective function is optimized, and
the vehicles are scheduled for charging during the opening hours.

23. The method of claim 17, wherein:
identifying charging station candidates includes determining a time window for the requesting vehicles, and the linear constraints are adapted so that the requesting vehicles are exclusively allocated to a charging station during the time window; and
the method further comprises:
determining a departure time for each of the requesting vehicles so that each of the requesting vehicles is estimated to arrive to the charging station before the start of the time window.

24. The method of claim 17, wherein:
the linear constraints include:
s_{i,j}≥q_{k,j} or s_{k,j}≥q_{i,j}∀j∈C∀i,k∈U(j)i≠k
where
$${s}_{i , j} = \{ \begin{matrix}charging start time at j , & if {e}_{i , j} = 1 \\ 0 , & otherwise\end{matrix}$$
for every user i∈U and charging station j∈C(i), which is the start of the time window;
q_{i,j} denotes the time vehicle i is finished charging at charging station j, which is the end of the time window.

25. The method of claim 17,
wherein at least one of the objective function or the linear constraints include a cost of charging each of the vehicles.

26. The method of claim 17, wherein:
each of the requests further identifies a current battery level and an energy consumption per distance unit for each of the requesting vehicles and at least one of the charging station data identifies at least one of a price per hour or price per energy unit; and
the cost of charging is derived from the current battery level, the energy consumption per distance unit, a distance to each of the charging stations, and at least one of the price per hour or the price per energy unit identified by the charging station data.

27. The method of claim 17,
wherein identifying the charging station candidates includes applying a branch and bound method to optimize the objective function with the linear constraints.

28. The method of claim 17, wherein
optimizing the objective function includes maximizing a function
$${\sum }_{i ∈ U} {\sum }_{j ∈ C ( i )} {e}_{i , j} - {σ}_{1} {\sum }_{i ∈ U} {\sum }_{j ∈ C ( i )} {e}_{i , j} * d e t o u {r}_{i , j} - {σ}_{2} {\sum }_{i ∈ U} {\sum }_{j ∈ C ( i )} {e}_{i , j} * p {c}_{i , j} \qquad$$
where i∈U denotes a set of vehicle identifiers;
j∈C(i) denotes a set of charging station identifiers;
e_{i,j} is a binary variable that is 1 if a vehicle i will visit a charging station j, and 0 otherwise;
detour_{i,j} denotes a charging station detour distance for the vehicle i if driving via charging station locations j on a way from the departure location to the arrival location of the vehicle i;
pc_{i,j} denotes the cost of charging the vehicle i at the charging station j; and
σ₁ and σ₂ are predefined hyperparameters in a range of:
$$0 < {σ}_{1} \leq \frac{1}{{max}_{i , j} {detour}_{i , j}} \\ 0 < {σ}_{2} \leq \frac{1}{{max}_{i , j} ( p {c}_{i , j} )}$$

29. The method of claim 17, wherein the linear constraints include at least one of:
$$\{ \begin{matrix}{s}_{i , j} \geq ( t {s}_{i} + t s {c}_{i , j} ) * {e}_{i , j} & ∀ i ∈ U , ∀ j ∈ C ( i ) \\ {s}_{i , j} \leq ( t {e}_{i} + t s {c}_{i , j} ) * {e}_{i , j} . & ∀ i ∈ U , ∀ j ∈ C ( i )\end{matrix} \\ or \\ \{ \begin{matrix}{s}_{i , j} \geq o {s}_{j} * {e}_{i , j} & ∀ i ∈ U , ∀ j ∈ C ( i ) \\ {s}_{i , j} + d {u}_{i , j} * {e}_{i , j} \leq o {e}_{j} * {e}_{i , j} & ∀ i ∈ U , ∀ j ∈ C ( i )\end{matrix} \qquad$$
where
e_{i,j} is a binary variable that is 1 if a vehicle i will visit a charging station j, and 0 otherwise;
tsc_{i,j} denotes a travel time between a departure location of the vehicle i and a charging station location of the charging station j;
tsᵢ and teᵢ are an earliest departure time and a latest departure time respectively for the vehicle i;
$${s}_{i , j} = \{ \begin{matrix}charging start time at j , & if {e}_{i , j} = 1 \\ 0 , & otherwise\end{matrix}$$
for each vehicle i∈U and each 0, otherwise charging station j∈C(i);
osⱼ and oeⱼ are an opening time and a closing time respectively for the charging station j; and
du_{i,j} denotes a charging time for the vehicle i at the charging station j.

30. A computer product comprising a non-transitory computer readable medium having stored thereon program code which, when executed on a processor, carries out the acts of:
receiving charging station data, the charging station data identifying one or more charging stations and charging station locations;
receiving one or more requests to charge one or more requesting vehicles, each request comprising data identifying a departure location and an arrival location of the respective requesting vehicle;
at least one of receiving or determining detours data, the detours data indicating at least one charging station detour distance for a plurality of vehicles, the plurality of vehicles including the requesting vehicles;
identifying charging station candidates for the requesting vehicles by optimizing an objective function with linear constraints; and
allocating at least some of the charging station candidates to the requesting vehicles;
wherein optimizing the objective function with linear constraints includes reducing at least one of a total detour distance, waiting times in queues, or prices for charging for the requesting vehicles.

31. A charging station allocation system comprising:
a charging station allocation unit; and
a charging station;
wherein the charging station allocation unit is configured to carry out a method comprising:
receiving charging station data, the charging station data identifying one or more charging stations and charging station locations;
receiving one or more requests to charge one or more requesting vehicles, each request comprising data identifying a departure location and an arrival location of the respective requesting vehicle;
at least one of receiving or determining detours data, the detours data indicating at least one charging station detour distance for a plurality of vehicles, the plurality of vehicles including the requesting vehicles;
identifying charging station candidates for the requesting vehicles by optimizing an objective function with linear constraints; and
allocating at least some of the charging station candidates to the requesting vehicles;
wherein optimizing the objective function with linear constraints includes reducing at least one of a total detour distance, waiting times in queues, or prices for charging for the requesting vehicles; and
wherein the charging station allocation unit is further configured to, based on a result of the allocating, send a signal to the charging station, the signal including an allocation message relating to a particular requesting vehicle and a corresponding time window.

32. The charging station allocation system of claim 31, wherein:
the charging station is configured to identify the particular requesting vehicle; and
the charging station allocation system prevents vehicles other than the particular requesting vehicle from using the charging station during corresponding time windows.
